(19) United States
(12) Patent Application Publication
(10) Pub. No.: US 2017/0037677 A1
(43) Pub. Date: Feb. 9, 2017

(54) MOVABLE TELESCOPIC SHIELDING DEVICE

(71) Applicant: OME TECHNOLOGY CO., LTD., New Taipei City (TW)

(72) Inventors: CHIEN-HSIANG MIAO, Taipei City (TW); CHIEN-TSE TSENG, New Taipei City (TW)

(21) Appl. No.: 14/867,924

(22) Filed: Sep. 28, 2015

(30) Foreign Application Priority Data
Aug. 3, 2015 (TW) 104125101

(51) Int. Cl. E06B 9/02; E06B 3/44; E06B 3/30; E05D 15/16; E05F 15/00

(52) U.S. Cl. CPC E06B 9/02; E05D 15/165; E05F 15/00; E06B 3/30; E06B 3/4407; E05Y 2900/148; E06B 2009/005

(57) ABSTRACT

The instant disclosure illustrates a movable telescopic shielding device arranged on a wall of a building, including a fixed shielding unit, a movable shielding unit, two moving units, and a driving unit. The fixed shielding unit is positioned on the wall of the building. The fixed shielding unit includes a fixed shielding member and two bearing members positioned on the two opposite lateral ends of the fixed shielding member. The movable shielding unit includes a movable shielding member under the fixed shielding unit and two supporting members between the fixed shielding unit and the movable shielding unit. The two moving units connect the fixed shielding unit with the movable shielding unit, and the two moving units interconnect with the two bearing members respectively, and connect to the two supporting member respectively. The driving unit drives the movable shielding unit move back and forth.

### BACKGROUND

1. Technical Field

The present disclosure relates to a telescopic shielding device, in particular, to a telescopic shielding device arranged on the walls of buildings.

2. Description of Related Art

The shielding devices (such as a rain shield) of the prior art generally consist of canvas, and a telescopic supporting structure and retracting structure. When opening the shielding device, the canvas is released by the retracting structure, and the canvas is expanded by the telescopic supporting structure. When retracting the shield device, the canvas may be retracted by the retracting structure, and the canvas may be folded by the telescopic supporting structure. However, the shielding device made from canvas has poor strength, is not steady and aesthetically pleasing.

In addition, there is a fixed shielding structure of the prior art arranged on the walls of the buildings, which supports hard materials such as glass or acrylic by a non-retractable supporting structure. However, due to the non-retractability, the fixed shielding structure has limitation in the applicable space and regulations where it can be deployed, and lacks user flexibility.

Accordingly, there is a need to provide a movable telescopic shielding device arranged on a wall of a building to overcome the above disadvantages.

### SUMMARY

The instant disclosure is aimed at providing a movable telescopic shielding device arranged on a wall of a building in view of the deficiency of the prior art. According to the telescopic design, the movable telescopic shielding device may be used in conjunction with shielding members with hard material.

To accomplish the above object, the embodiment of the instant disclosure provides a movable telescopic shielding device arranged on a wall of a building, the movable telescopic shielding device comprises a fixed shielding unit, a movable shielding unit, two moving units, and a driving unit. The fixed shielding unit is fixed on the wall of the building, wherein the fixed shielding unit comprises a fixed shielding member and two bearing units, the two bearing units are positioned on the two opposite lateral ends of the fixed shielding member. The movable shielding unit comprises a movable shielding member positioned under the fixed shielding unit and two supporting members positioned between the fixed shielding unit and the movable shielding unit. The two moving units connect the fixed shielding unit with the movable shielding unit, and the two moving units connect to the two bearing members respectively, and interconnect with the two supporting units respectively. The driving unit is positioned on the fixed shielding unit, the movable shielding unit, or the moving units, wherein the driving unit drives the movable shielding unit to move back and forth.

The advantage of the instant disclosure resides in that by using the movable telescopic shielding device provided by the instant disclosure, it is able to position the moving units between the fixed shielding unit and movable shielding unit, and hence, the movable shielding unit positioned under the fixed shielding unit may have a transverse length larger than or equal to the transverse length of the fixed shielding unit. Furthermore, by positioning the rail module on the bearing surface of the bearing units and the slider module on the bearing module connected with the movable shielding unit, it is able to form an inverted (upside down) linear slide rail. Accordingly, the movable shielding unit positioned below may move or slide back and forth, and the appearance will be more pleasing.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a three-dimensional assembly schematic view of one of the movable telescopic shielding devices of an embodiment of the instant disclosure.

FIG. 2 is a side view of the movable telescopic shielding device of an embodiment of the instant disclosure.

FIG. 3 is another three-dimensional assembly schematic view of the movable telescopic shielding device of an embodiment of the instant disclosure.

FIG. 4 is a three-dimensional exploded view of one of the movable telescopic shielding device of an embodiment of the instant disclosure.

FIG. 5 is a partial enlargement of part A of FIG. 4.

FIG. 6 is another three-dimensional exploded view of the movable telescopic shielding device of an embodiment of the instant disclosure.

FIG. 7 is a partial enlargement of part B of FIG. 6.

FIG. 8 is a partial three-dimensional assembly schematic view of the movable telescopic shielding device of an embodiment of the instant disclosure.

### DESCRIPTION OF THE EXEMPLARY EMBODIMENTS

Reference will now be made in detail to the exemplary embodiments of the movable telescopic shielding device of the instant disclosure, examples of which are illustrated in the accompanying drawings. Wherever possible, the same reference numbers are used in the drawings and the description to refer to the same or like parts.

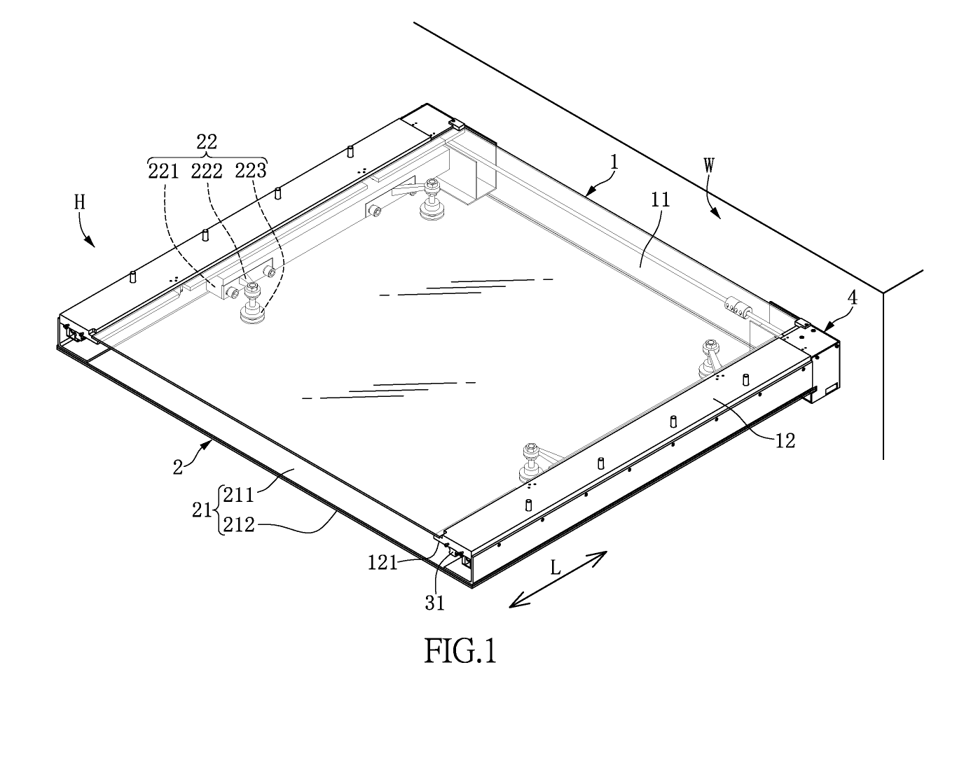

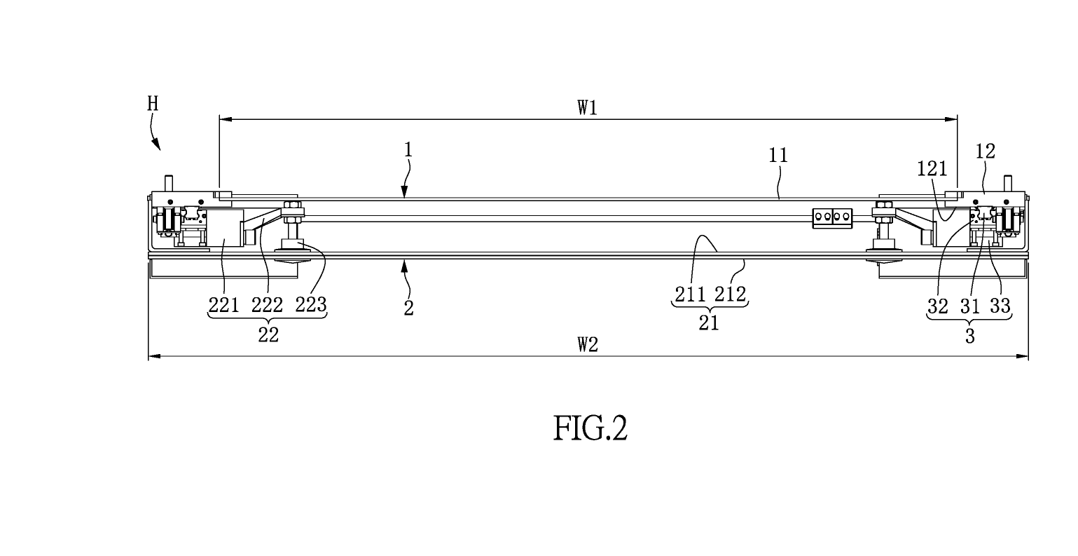

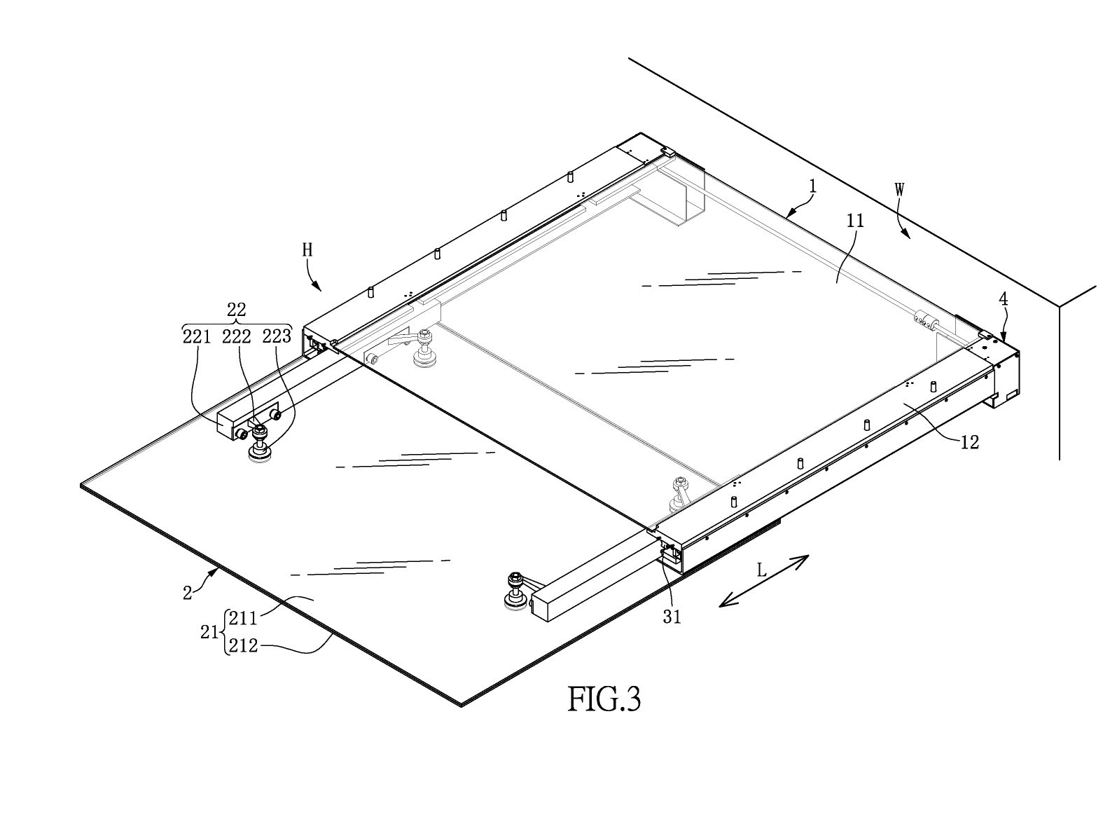

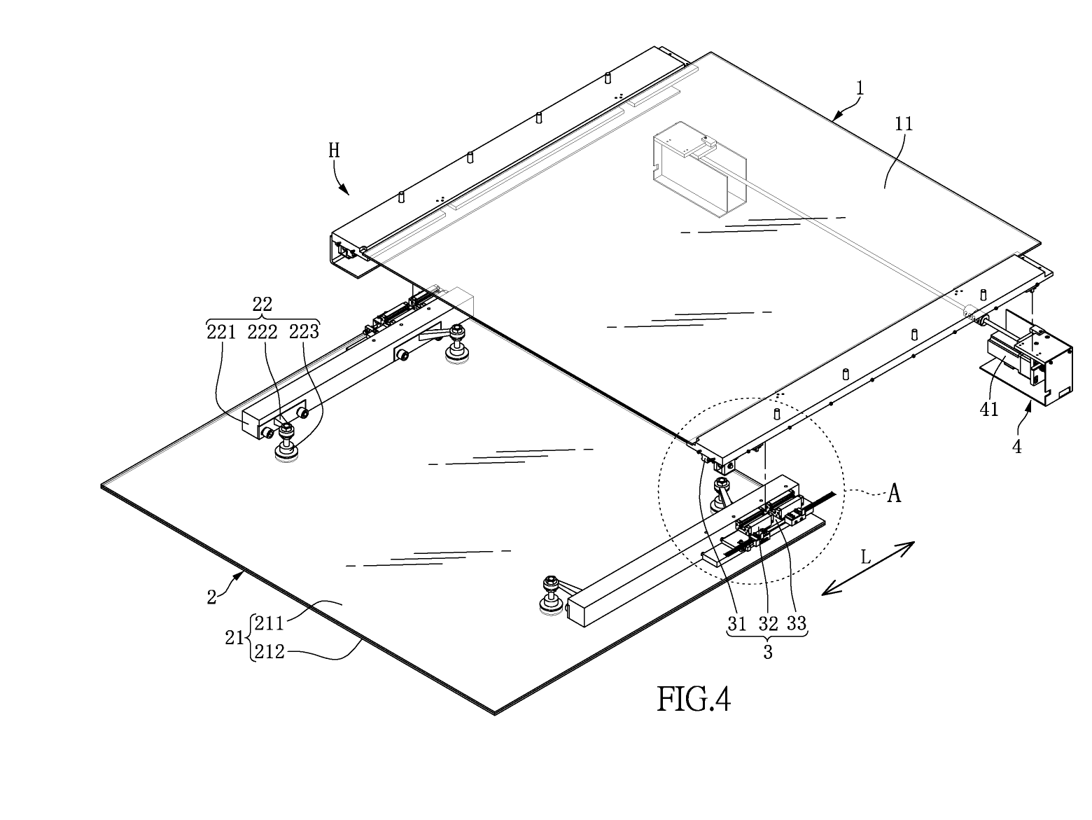

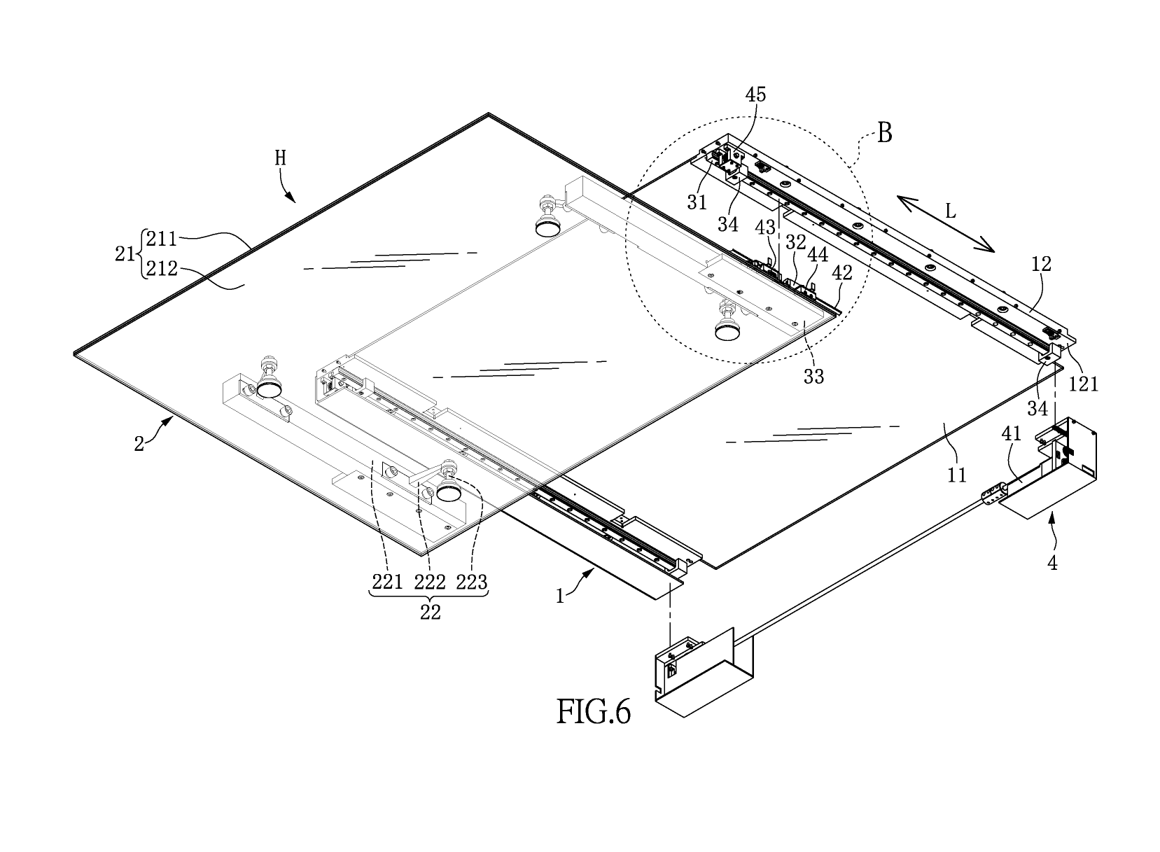

First, please refer to FIGS. 1 to 3 and also refer to FIGS. 4 and 6. FIG. 1 is a three-dimensional assembly schematic view of one of the movable telescopic shielding device of an embodiment of the instant disclosure, FIG. 2 is a side view of the movable telescopic shielding device of the embodiment of the instant disclosure, FIG. 3 is another three-dimensional assembly schematic view of the movable telescopic shielding device of an embodiment of the instant disclosure, FIG. 4 is a three-dimensional exploded view of one of the movable telescopic shielding device of an embodiment of the instant disclosure, and FIG. 6 is another three-dimensional exploded view of the movable telescopic shielding device of an embodiment of the instant disclosure. An embodiment of the instant disclosure provides a movable telescopic shielding device H arranged on a wall of a building, the movable telescopic shielding device H comprises a fixed shielding unit 1, a movable shielding unit 2, two moving units 3, and a driving unit 4. The movable shielding unit 2 may be positioned under the fixed shielding unit 1, and the movable shielding unit 2 may be slidably connected to the fixed shielding unit 1 by the two moving units 3. In other words, when the movable shielding device H is arranged on the wall of the building, the distance between the movable shielding unit 2 and the ground level is smaller than the distance between the fixed shielding unit 1 and the ground level.

Next, specifically, the fixed shielding unit 1 is fixed on the wall of the building. Furthermore, it is worthwhile to mention that it is able to first position a supporting structure such as a steel beam (not shown) on the wall of the building, and then fix the fixed shielding unit 1 to said supporting structure. In regard to this embodiment of the instant disclosure, the fixed shielding unit 1 may comprise a fixed shielding member 11 and two bearing members 12, and the two bearing members 12 may be positioned on the two opposite lateral ends of the fixed shielding member 11 respectively. For instance, the fixed shielding member 11 may be made from high strength hard materials such as materials having no flexibility, for example, metal, acrylic or glass. However, the material of the fixed shielding member 11 is not limited. Besides, the fixed shielding member 11 may be made from a transparent material or a light-transmitting material, in order to allow the sunlight to pass through and protect objects or people from rain. Furthermore, for instance, the fixed shielding member 11 may cross the two bearing members 12, and be supported by the bearing members 12 positioned on the two lateral ends of the fixed shielding member 11, to fix the shielding unit 1 on the wall of the building.

The movable shielding unit 2 is positioned under the fixed shielding unit 1 and slidably connects to the fixed shielding unit 1. To be specific, the movable shielding unit 2 comprises a movable shielding member 21 positioned under the fixed shielding unit 1 and two supporting members 22 positioned between the fixed shielding unit 1 and the movable shielding unit 2. It is worthwhile to mention that the movable shielding member 21 may be made from a hard material with high strength, such as materials having no flexibility, for example, metal, acrylic or glass. However, the material of the movable shielding member 21 is not limited. Furthermore, the movable shielding member 21 may be a made from a transparent material or a light-transmitting material, in order to allow the sunlight to pass through and protect objects or people from rain. Furthermore, for instance, each of the supporting members 22 may comprise a base 221, a foot piece 222, and a clamping base 223. One end of the clamping base 223 may have a clamping portion (not symbolized) clamping an upper surface 211 and a lower surface 212 of the movable shielding member 21. The other end of the clamping base 223 may be connected to the foot piece 222, thereby connecting the foot piece 222 between the base 221 and the clamping base 223. In other words, in regards to this embodiment of the instant disclosure, the base 221 and foot piece 222 are both positioned on the movable shielding member 21. In addition, the base 221 may be positioned on the moving unit 3, and by connecting the base 221 to the moving unit 3, the movable shielding unit 2 is driven by the driving unit 4 and moves back and forth between a first position near to the wall and a second position far from the wall.

It is worthwhile to mention that the clamping base 223 may be a glass grabbing member, and since the movable shielding member 21 is positioned under the fixed shielding unit 1, the glass grabbing member would clamp the movable shielding member 21 downwardly, and hence, the foot piece 222 connected to the clamping base 223 would be subjected to the downwardly pulling force of the movable shielding member 21. Therefore, such an arrangement applies a force different from the prior art fixed shielding structure which supports the movable shielding member 21 upwardly by the supporting structure and the glass grabbing member. Furthermore, please refer to FIG. 2, FIG. 2 shows that the fixed shielding member 11 may have a first predetermined width W1 and the movable shielding member 21 may have a second predetermined width W2. Preferably, since when the movable shielding unit 2 moves outwardly from the wall, the range of the transverse width of the movable shielding unit 2 resulting must be equal to or larger than the range of the transverse width of the fixed shielding unit 1. The second predetermined width W2 of the movable shielding member 21 may be larger than or equal to the first predetermined width W1 of the fixed shielding member 11. However, in other embodiments, another movable shielding unit (not shown) may be positioned under the movable shielding member 21 to enable the movable telescopic shielding device H provided by the instant disclosure to further extend. Furthermore, the movable shielding unit (not shown) positioned under the movable shielding member 21 may be positioned and extended vertical to the long axis direction L of the rail module 31, i.e., it may be telescopically positioned in the transverse direction.

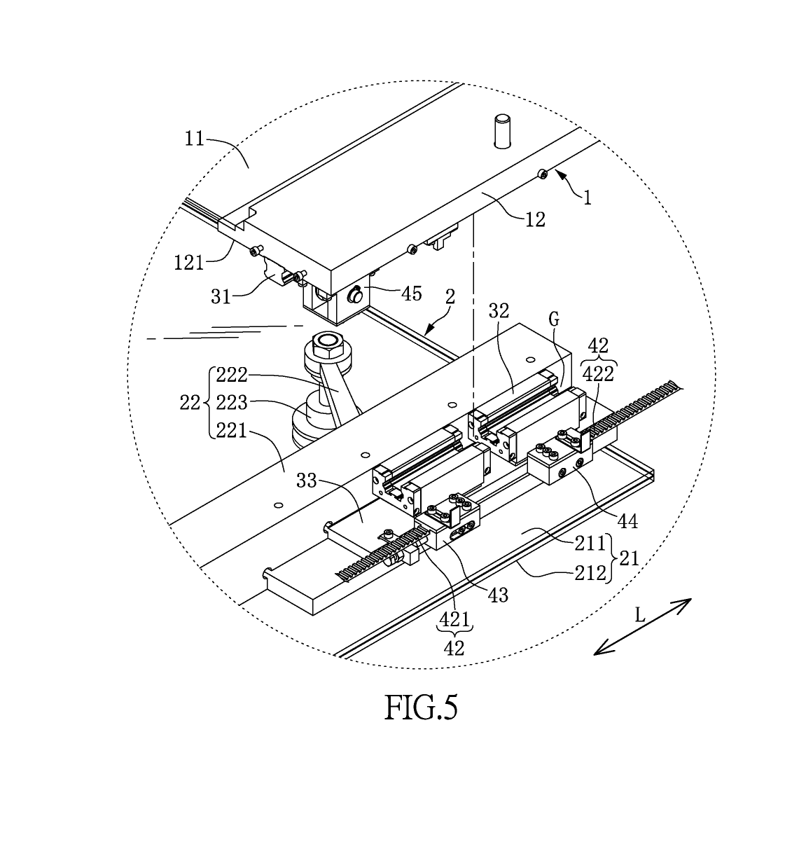

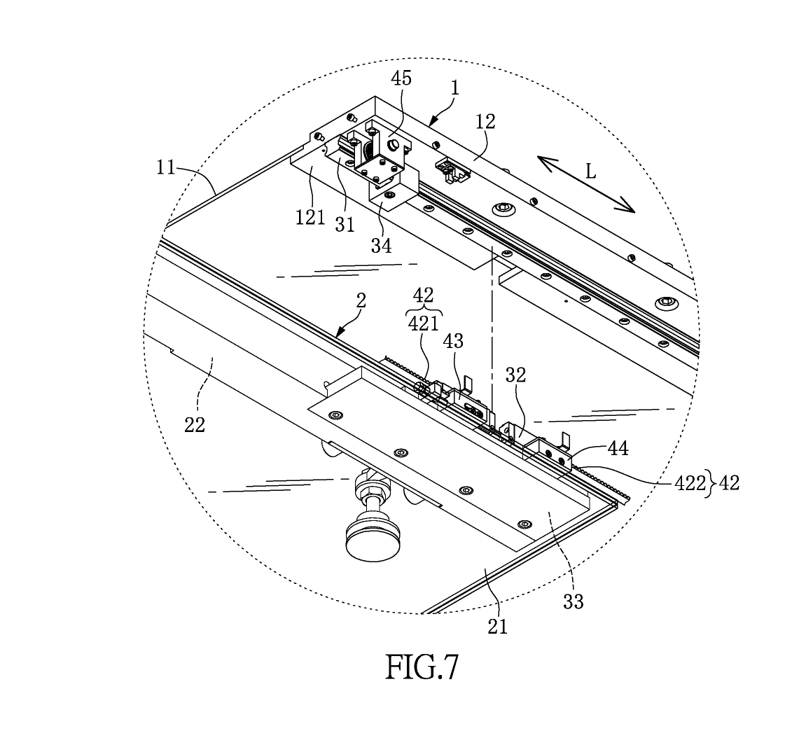

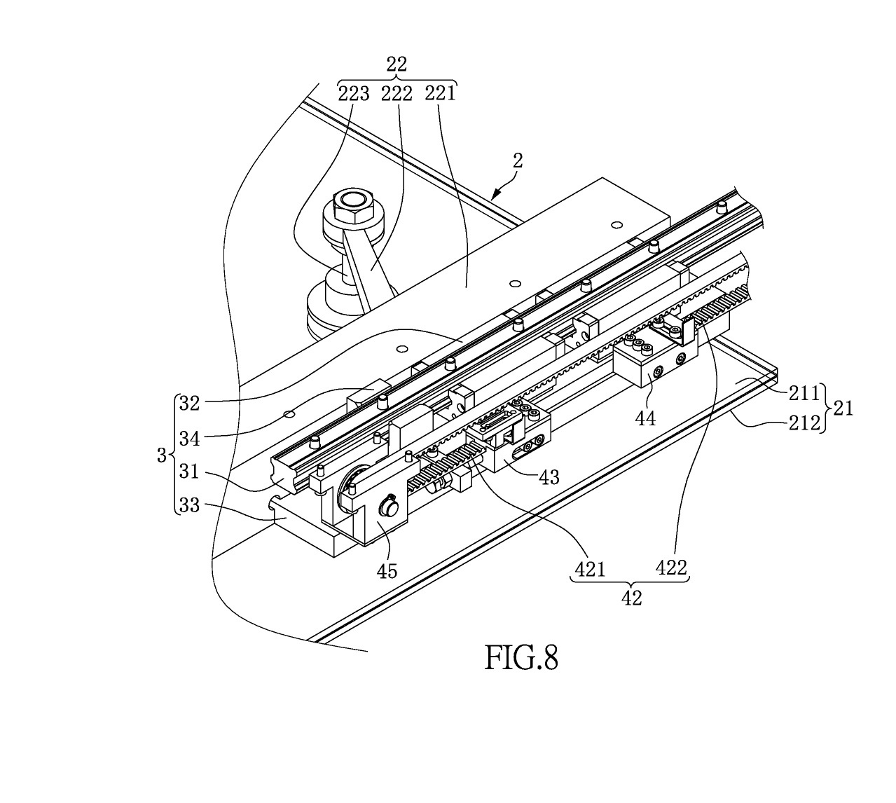

Next, please refer to FIG. 4 to FIG. 8. FIG. 5 is a partial enlargement of the part A of FIG. 4, FIG. 7 is a partial enlargement of the part B of FIG. 6, and FIG. 8 is a partial three-dimensional assembly schematic view of the movable telescopic shielding device of an embodiment of the instant disclosure. The two moving units 3 may be connected between the fixed shielding unit 1 and the movable shielding unit 2, and the two moving units 3 are connected to the two bearing members 12 and interconnected with the two supporting members 22 respectively. To be specific, in regard to the embodiment of the instant disclosure, each of the bearing units 12 has a bearing surface 121 on the bottom thereof (the lower surface under the bearing member 12), and the two moving units 3 may be connectively positioned on the bearing surfaces of the two bearing member 12 respectively. In other words, in regard to the embodiment of the instant disclosure, the bearing surfaces 121 under the bearing members 12 are face to the movable shielding unit 2.

For instance, each of the moving units 3 may include a rail module 31, a slider module 32 and a bearing module 33. The rail module 31 may be positioned on the bearing surface 121 by a plurality of fixing members (not shown), the slider module 32 may be positioned on the bearing module 33, and the bearing module 33 connects to the supporting member 22 of the movable shielding unit 2. For instance, the rail module 31 and the slider module 32 may cooperate with each other forming a linear slide rail. The rail module 31 is linear and has a long axis direction L, and the rail module 31 has two guiding trenches (not shown) positioned on the two opposite sides of the rail module 31 respectively. The guiding trenches may be recessively formed on the two opposite sides of the rail module 31 and parallel to the long axis direction L, so that the cross-section vertical to the long axis direction L is substantially in an “I” form. Furthermore, the slider module 32 has an accommodating trench G which is slidably engaged with the rail unit 31. In other words, the accommodating trench G is recessively positioned on the slider module 32 and thus, the cross-section of the slider module 32 which is vertical to the long axis direction L is substantially in a “U” form.

By positioning the rail module 31 and the slider module 32 on the bearing member 12 and bearing module 33 separately and respectively, the movable shielding unit 2 may move back and forth along the long axis direction L, and when the movable shielding unit 2 extends from the wall, the transverse width of the movable shielding unit 2 would be equal to or larger than the transverse width of the fixed shielding unit 1. In other words, preferably, the moving units 3 of the movable telescopic shielding device H provided by the embodiment of the instant disclosure are linear slide rails that are positioned upside down. In addition, the moving units 3 are positioned between the fixed shielding unit 1 and the movable shielding unit 2. Therefore, the transverse width of the movable shielding unit 2 under the fixed shielding unit 1 is larger than the fixed shielding unit 1, i.e., the size of the movable shielding member 21 below may be larger than that of the fixed shielding member 11. Accordingly, in other embodiments, when connecting a plurality of movable telescopic shielding devices H sequentially, each two of the movable shielding units 2 are adjacent to each other and positioned under the movable shielding unit 2, and the gap between the two adjacent movable shielding units 2 would be smaller or there will even be no gap between the two adjacent movable shielding units 2. In other words, the moving units 3 are positioned on the upper surface 211 of the movable shielding member 21 rather than positioned on the side surface (not shown) connected between the upper surface 211 and the lower surface 212.

Then, the driving unit 4 may be positioned on the fixed shielding unit 1, the movable shielding unit 2, or the moving units 3. Therefore, the driving unit 4 may drive the movable shielding unit 2 to move back and forth between the first position and the second position. To be specific, the driving unit 4 may drive the bearing module 33 to move, thereby moving the movable shielding unit 2 back and forth. Preferably, for instance, regarding the embodiment of the instant disclosure, the driving unit 4 may comprise a driving member 41 (such as a motor), an open type belt 42, a first belt adjusting block 43, and a second belt adjusting block 44. The driving member 41 may be positioned in a housing (not shown), and the housing may be positioned on the bearing member 12 of the fixed shielding unit 1. It is worthwhile to mention that in order to identify the position of the driving member 41, the graphs shown in FIGS. 4 and 6 omit one part of the housing that covers the driving member 41. In addition, each of the two opposite lateral ends of the bearing member 12 may have a direction-changing axle 45 to change the direction of the open type belt 42.

The first belt adjusting block 43 and the second belt adjusting block 44 may be positioned on the bearing module 33 to move the first belt adjusting block 43 and the second belt adjusting block 44 by the driving member 41, thereby moving the bearing module 33 to drive the movable shielding unit 2. To be specific, the open type belt 42 may have a first lateral end 421 and a second lateral end 422, the first lateral end 421 may be positioned on the first belt adjusting block 43, and the second lateral end 422 may be positioned on the second belt adjusting block 44. Therefore, when the driving member 41 rotates, it may drive the open type belt to move or rotate, and the first lateral end 421 and the second lateral end 422 of the open type belt may pull the first belt adjusting block 43 and the second belt adjusting block 44, therefore moving the slider module 32 indirectly. Therefore, the movable shielding unit 2 connected with the bearing module 33 may be moved as well. However, it is worthwhile to mention that the instant disclosure is not limited to the above description, for instance, the driving unit 4 may be a part consisting of a cylinder or a rack for moving the slider module 32 on the rail module 31. Furthermore, it is worth to mention that the two opposite ends of the rail module 31 may have a stopping block 34 positioned thereon to avoid the slider module 32 becoming disassembled from the rail module 31 when moving back and forth between the first position and the second position.

### Possible Effect Achieved by the Embodiments

In summary, the advantages of the instant disclosure reside in that the movable telescopic shielding device H provided by the instant disclosure has moving units 3 positioned between the fixed shielding unit 1 and movable shielding unit 2, and thus, the transverse width of the movable shielding unit 2 positioned under the fixed shielding unit 1 may be larger than or equal to the transverse width of the fixed shielding unit 1. Furthermore, the instant disclosure forms an upside down linear slider rail by positioning the rail module 31 on the bearing surface 121 of the bearing member 12 and positioning the slider module 32 on the bearing module 33 connected with the movable shielding unit 2. Therefore, the movable shielding unit 2 positioned below may move back and forth, and the device is aesthetically pleasing. In addition, when the movable telescopic shielding device H provided by the embodiment of the instant disclosure serves as a rain shield, the fixed shielding unit 1 positioned on the wall of the building may be inclinedly positioned and thus, the rain may fall on the fixed shielding member 11 and the movable shielding member 21 sequentially. Furthermore, the fixed shielding member 11 and the movable shielding member 21 having higher strength than the canvas of the prior art may provide a movable telescopic shielding device H which is more aesthetically pleasing and has better ruggedness.

The above-mentioned descriptions represent merely the exemplary embodiment of the instant disclosure, without any intention to limit the scope of the instant disclosure thereto. Various equivalent changes, alterations or modifications based on the claims of the instant disclosure are all consequently viewed as being embraced by the scope of the instant disclosure.

1. A movable telescopic shielding device positioned on a wall of a building, comprising:
a fixed shielding unit, the fixed shielding unit is fixed on the wall of the building, wherein the fixed shielding unit comprises a fixed shielding member and two bearing members, the two bearing members are positioned at two opposite lateral ends of the fixed shield member respectively;
a movable shielding unit, the movable shielding unit comprises a movable shielding member positioned under the fixed shielding unit and two supporting members positioned between the fixed shielding unit and the movable shielding unit member;
two moving units, the two moving units connect the fixed shielding unit with the moving shielding unit, and the two moving units interconnect with the two supporting members respectively, and
a driving unit, the driving unit is positioned on the fixed shielding unit, the movable shielding unit or the moving units, wherein the driving unit drives the movable shielding unit to move back and forth between a first position near to the wall and a second position second position far from the wall;
wherein the fixed shielding member has a first predetermined width, the movable shielding member has a second predetermined width, and the second predetermined width is larger than or equal to the first predetermined width.

2. The movable telescopic shielding device according to claim 1, wherein each of the supporting members comprise a base, a foot piece and a clamping base, the clamping base clamps an upper surface and a lower surface of the movable shielding member, the foot piece is positioned between the base and the clamping base, the base is positioned on the moving units, the movable shielding unit is driven by the driving unit and moves back and forth between a the first position and a the second position.

3. The movable telescopic shielding device according to claim 2, wherein the base and the foot piece are positioned above the movable shielding member.

4. The movable telescopic shielding device according to claim 1, wherein the fixed shielding member and the movable shielding member are made from metal, acrylic or glass.

5. The movable telescopic shielding device according to claim 1, wherein each of the bearing members has a bearing surface at a bottom end thereof, and the two moving units are positioned on the two bearing surfaces of the two bearing members respectively.

6. The movable telescopic shielding device according to claim 5, wherein each of the moving units comprises a rail module, a slider module, and a bearing module, the rail module is positioned on the bearing surface, the slider module is positioned on the bearing module, and the bearing module is connected to the supporting members, the rail module is in the form of a long strip and has a major axis direction, the slider module has an accommodating trench, and the accommodating trench is slidably engaged with the rail module.

7. (canceled)

8. The movable telescopic shielding device according to claim 1, wherein the driving unit comprises a driving member, an open type belt, a first belt adjusting block, and a second belt adjusting block, the first belt adjusting block and the second belt adjusting block are positioned on the bearing module, the open type belt has a first lateral end part and a second lateral end part, the first lateral end part is positioned on the first belt adjusting block, and the second lateral end part is positioned on the second belt adjusting block, the driving member drives the open type belt to move back and forth.

9. (canceled)

10. The movable telescopic shielding device according to claim 1, wherein the fixed shielding member and the movable shielding member are made from transparent material or light-transmitting material.
